(19) United States
(12) Patent Application Publication
(10) Pub. No.: US 2010/0062813 A1
(43) Pub. Date: Mar. 11, 2010

(54) POWER AMPLIFIER LOAD LINE SWITCH FOR A PORTABLE TRANSCEIVER

(75) Inventors: Jon Kujanski, Cedar Rapids, IA (US); Philip H. Thompson, Solon, IA (US)

Correspondence Address: SMITH FROHWEIN TEMPEL GREENLEE BLAHA, LLC, Two Ravinia Drive, Suite 700, ATLANTA, GA, 30346, US

(73) Assignee: SKYWORKS SOLUTIONS, INC., Woburn, MA (US)

(21) Appl. No.: 12/207,581

(22) Filed: Sep. 10, 2008

(51) Int. Cl. H04B 1/00; H04M 1/00

(52) U.S. Cl. 455/571; 455/127.5

(57) ABSTRACT

In a portable radio transceiver, a power amplifier system includes a load line switch that operates in response to a mode control signal to promote high efficiency in both a high-power mode and a low-power mode. The switching circuit is operable to couple the inductance to the shunt capacitance in response to a control signal indicating operation in a low-power mode. The switching circuit is further operable to decouple the inductance from the shunt capacitance in response to a control signal indicating operation in a high-power mode. In the low-power mode, the inductance couples with the shunt capacitance to decrease total capacitance at the output of the power amplifier. In the high-power mode, the total capacitance at the output of the power amplifier is substantially equal to the shunt capacitance alone, and the inductance essentially has no effect on total capacitance at the power amplifier output.

### BACKGROUND

Radio frequency (RF) transmitters of the type used in mobile wireless telephones (also known as cellular telephones) and other portable radio transceivers commonly include transmit power control circuitry that adjusts the power of the transmitted RF signal. The power control circuitry can adjust a power amplifier to increase or decrease the transmitted RF power. Adjusting transmitted RF power is useful for several purposes. In many types of cellular telecommunications systems, it is useful for transmitted RF power to be higher when the handset is farther from the nearest base station and lower when the handset is closer to the nearest base station. Advantages of adjusting transmitted RF power in response to the distance to the nearest base station include promoting amplifier operating efficiency and battery life. Also, in some types of dual-mode transceivers, such as those that are capable of operating in accordance with both the GSM (Global System for Mobile telecommunication) standard and EDGE (Enhanced Data rates for GSM Evolution) standard, requirements for transmitted RF power differ depending on whether the transceiver is operating in GSM mode or EDGE mode.

A power amplifier generally operates more efficiently at peak or saturated output power than at a lower output power. Therefore, decreasing, or backing off, the output power in response to a decrease in distance to the nearest base station can impair amplifier efficiency. Likewise, the efficiency of an amplifier that is used in both a GSM mode and an EDGE mode may be necessarily lower in EDGE mode than in GSM mode because the GSM specification (or, more specifically, the specification for the GMSK (Gaussian Minimum-Shift Keying) modulation used in GSM networks) specifies a higher output power (typically 33.5 dBm) than the EDGE specification (typically 31.7 dBm) specifies.

A load line switch is a circuit that allows the amplifier peak output power to be adjusted. Load line analysis is a well-known graphical technique for analyzing the impact of other circuit elements on the amplifier. Thus, for example, when amplifier output power is decreased (e.g., switched to a low-power mode), the load line switch can accordingly decrease amplifier peak output power, and when amplifier output power is increased (e.g., switched to a high-power mode), the load line switch can accordingly increase amplifier peak output power. By decreasing amplifier peak output power, amplifier efficiency remains substantially constant as output power is backed off.

It has been suggested to include load line switches in some types of transmitter power amplifier circuits. Some load line switches have utilized PIN (positive-intrinsic-negative) diodes to switch additional shunt capacitance into the amplifier circuit when output power is increased (e.g., when the amplifier is switched to a high-power mode). Such additional capacitance lowers the amplifier's load line, thereby substantially maintaining amplifier efficiency at the higher output power. While such a load line switch may be useful in theory, in practice providing feasible circuitry, such as circuitry for biasing the diode, is problematic.

### SUMMARY

Embodiments of the invention relate to a power amplifier system in a portable radio frequency (RF) transmitter or transceiver, to a mobile wireless telecommunication device having such a transceiver, and to a method of operation of the power amplifier system, where the power amplifier system includes a load line switch that operates in response to a mode control signal.

In an exemplary embodiment, the power amplifier circuit includes a power amplifier operable in a high-power mode and a low-power mode, an inductance coupled to an output of the power amplifier, and a switching circuit. The switching circuit is operable to couple the inductance to the shunt capacitance in response to a control signal indicating operation in a low-power mode. The switching circuit is further operable to decouple the inductance from the shunt capacitance in response to a control signal indicating operation in a high-power mode. In the low-power mode, the inductance couples with the shunt capacitance to decrease total capacitance at the output of the power amplifier. In the high-power mode, the total capacitance at the output of the power amplifier is substantially equal to the shunt capacitance alone, and the inductance essentially has no effect on total capacitance at the power amplifier output.

Other systems, methods, features, and advantages of the invention will be or become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE FIGURES

The invention can be better understood with reference to the following figures. The components within the figures are not necessarily to scale, emphasis instead being placed upon clearly illustrating the principles of the invention. Moreover, in the figures, like reference numerals designate corresponding parts throughout the different views.

FIG. 1 is a block diagram of a mobile wireless telephone, in accordance with an exemplary embodiment of the present invention.

FIG. 2 is a block diagram of the transmitter portion of the mobile wireless telephone shown in FIG. 1.

FIG. 3 is a block diagram of the power amplifier system of the transmitter portion shown in FIG. 2.

FIG. 4 is a block diagram similar to FIG. 3, showing the power amplifier system controller.

FIG. 5 is a flow diagram, illustrating a method of operation of the power amplifier system shown in FIGS. 3-4.

FIG. 6 is a graph showing power-added efficiency (PAE) plotted against output power at a typical operational frequency.

FIG. 7 is a graph showing PAE plotted against output power at a typical operational frequency.

### DETAILED DESCRIPTION

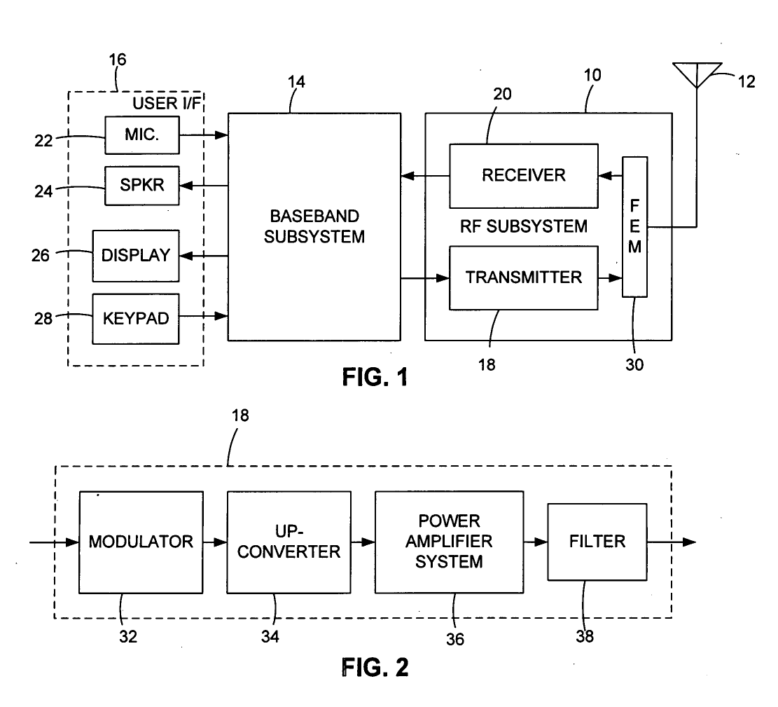

As illustrated in FIG. 1, in accordance with an exemplary embodiment of the invention, a mobile wireless telecommunication device, such as a cellular telephone, includes a radio frequency (RF) subsystem 10, an antenna 12, a baseband subsystem 14, and a user interface section 16. The RF subsystem 10 includes a transmitter portion 18 and a receiver portion 20. User interface section 16 includes a microphone 22, a speaker 24, a display 26, and a keyboard 28, all coupled to baseband subsystem 14. The output of transmitter portion 18 and the input of receiver portion 20 are coupled to antenna 12 via a front-end module (FEM) 30 that allows simultaneous passage of both the transmitted RF signal produced by transmitter portion 18 and the received RF signal that is provided to receiver portion 20. But for transmitter portion 18, the above-listed elements can be of the types conventionally included in such mobile wireless telecommunication devices. As conventional elements, they are well understood by persons of ordinary skill in the art to which the present invention relates and, accordingly, not described in further detail in this patent specification (“herein”). However, unlike conventional transmitter portions of such mobile wireless telecommunication devices, transmitter portion 18 embodies power amplifier load line switching features and methods, described in further detail below. It should be noted that while the invention is described in the context of an exemplary embodiment relating to a mobile wireless telephone, the invention alternatively can be embodied in other devices that include mobile or portable RF transmitters.

As illustrated in FIG. 2, a modulator 32 in exemplary transmitter portion 18 receives the signal that is input to transmitter portion 18. Modulator 32 modulates the input signal and provides the modulated signal to an upconverter 34. Upconverter 34 shifts or upconverts the frequency of the modulated signal from a baseband frequency to a transmit frequency and provides the upconverted signal to a power amplifier system 36. A filter 38 attenuates undesirable harmonics in the signal output by power amplifier system 36. Although not shown in FIG. 2 for purposes of clarity, power amplifier system 36 can also receive one or more control signals from a system controller, which can be included in baseband subsystem 14 or other suitable element. Such control signals typically relate to adjusting amplifier gain, bias, and other amplifier parameters. Further, it should be noted that the above-described transmitter portion 18 represents only one exemplary embodiment of a transmitter portion, and other embodiments are possible.

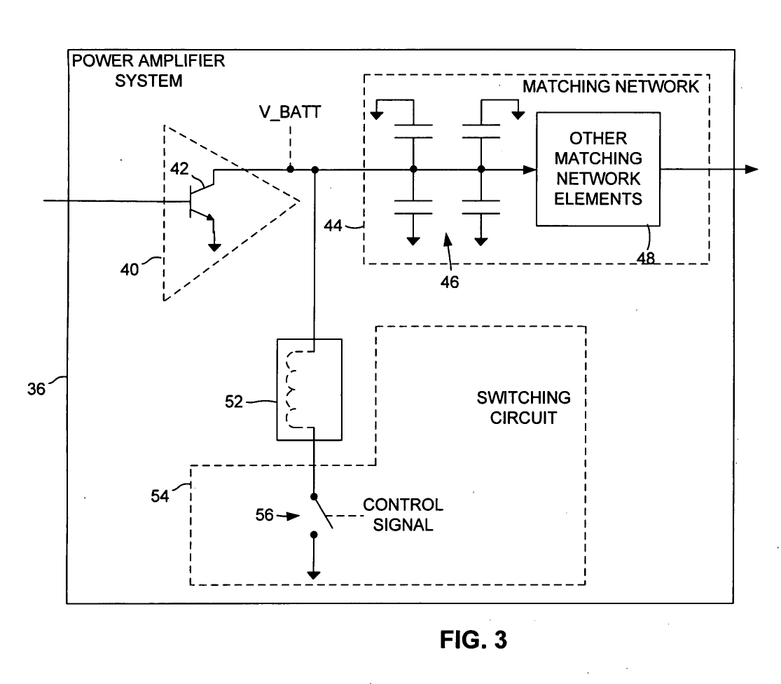

As illustrated in FIG. 3, power amplifier system 36 is based upon a power amplifier 40, which can be of a conventional type that includes at least one transistor 42 and other elements. For example, although not shown for purposes of clarity, power amplifier 40 can include several transistors in a cascade arrangement, as well as biasing circuitry and other elements. Although transistor 42 is depicted as being of the bipolar junction type, in other embodiments the transistor or transistors can be of any suitable type or types, arranged in any suitable manner.

Power amplifier system 36 further includes a matching network 44, which matches antenna impedance to power amplifier impedance. In an exemplary embodiment, a portion of matching network 44 comprises four shunt capacitors 46, each having a terminal coupled to the output of power amplifier 40 and a terminal coupled to circuit ground potential. (As used herein, the term “coupled” means connected via zero or more intermediate elements.) Such shunt capacitors are commonly included in power amplifier matching networks and can also serve to reduce peak voltages across power amplifier transistors in some power amplifier embodiments. Matching network 44 can further include any other suitable matching network elements 48. Such other matching network elements 48 can include suitable arrangements of capacitors and inductors (not shown for purposes of clarity), as known in the art. Although the exemplary embodiment includes four shunt capacitors 46, other embodiments can include any other suitable number of shunt capacitors. Furthermore, the term “shunt” capacitor is used herein for convenience to refer to a capacitor coupled to the output of power amplifier 40 (as that is the name by which such capacitors are commonly referred to in the art), and does not limit capacitors 46 to a shunting function or other functions unless otherwise explicitly stated herein.

Elements relating to the above-referenced power amplifier load line switching feature include an inductance 52 and a switching circuit 54. As illustrated by aspects of the exemplary embodiment described below, inductance 52 can comprise any suitable combination of one or more devices or structures that exhibit suitable inductance when the circuit is operating. Switching circuit 54 includes a switching device 56. Also, inductance 52, switching circuit 54, or both in combination, include suitable elements (not shown in FIG. 3 for purposes of clarity) that inhibit a DC path from the output of power amplifier 40 to ground, as in the exemplary embodiment the output of power amplifier 40 is coupled to a positive power supply voltage (V_BATT) provided by a battery-powered power supply circuit (not shown). The power supply circuit can be that which powers the various elements of the overall mobile wireless telecommunication device shown in FIG. 1. Such power supply circuitry is not shown for purposes of clarity but can be of the type commonly included in such mobile wireless telecommunication devices.

Switching device 56 is conceptually depicted as a switch in FIG. 3 to illustrate that it functions as a switch in that, when in the open or “OFF” state, it has a very large impedance (essentially functioning as an open circuit), and when in the closed or “ON” state, it has a very low impedance (essentially functioning as a closed circuit and thus providing a DC path to ground potential). An exemplary structure for switching device 56 is described below.

Switching device 56 operates in response to a control signal. Switching device 56 can be activated (i.e., closed) in an instance in which the control signal indicates a low-power mode, and deactivated (i.e., opened) in an instance in which the control signal indicates a high-power mode. Low-power and high-power modes refer to the transmitted RF power level or output power level. As one example of switching between a low-power mode and a high-power mode, the mobile wireless telecommunication device (FIG. 1) can operate in a high-power mode when it is relatively far from the nearest base station and can operate in a low-power mode when it is relatively close to the nearest base station. As another example of switching between a low-power mode and a high-power mode, a dual-mode mobile wireless telecommunication device can operate in a high-power mode when transmitting using GMSK technology (e.g., in accordance with the GSM specification), which specifies an output power rating of 33.5 dBm, and can operate in a low-power mode when transmitting in accordance with the EDGE specification, which specifies an output power rating of 31.7 dBm. It should be recognized that specification names and parameters, particularly specific numeric parameters mentioned in such specifications, are subject to change as technologies and specifications are developed and thus are only intended as examples herein.

In operation, as described below, the total capacitance at the output of power amplifier 40 is decreased in low-power mode and increased in high-power mode. As known in the art, capacitance at an amplifier output affects the amplifier load line. Thus, some prior load line switches add or increase capacitance when output power is increased. In contrast, in the exemplary embodiment, rather than increase capacitance at the output of power amplifier 40 to maintain amplifier efficiency in high-power mode (for example, by switching additional capacitors into the circuit along with shunt capacitors 46), capacitance at the output of power amplifier 40 is defined by the capacitance of shunt capacitors 46 in high-power mode and decreased below the capacitance of shunt capacitors 46 in low-power mode.

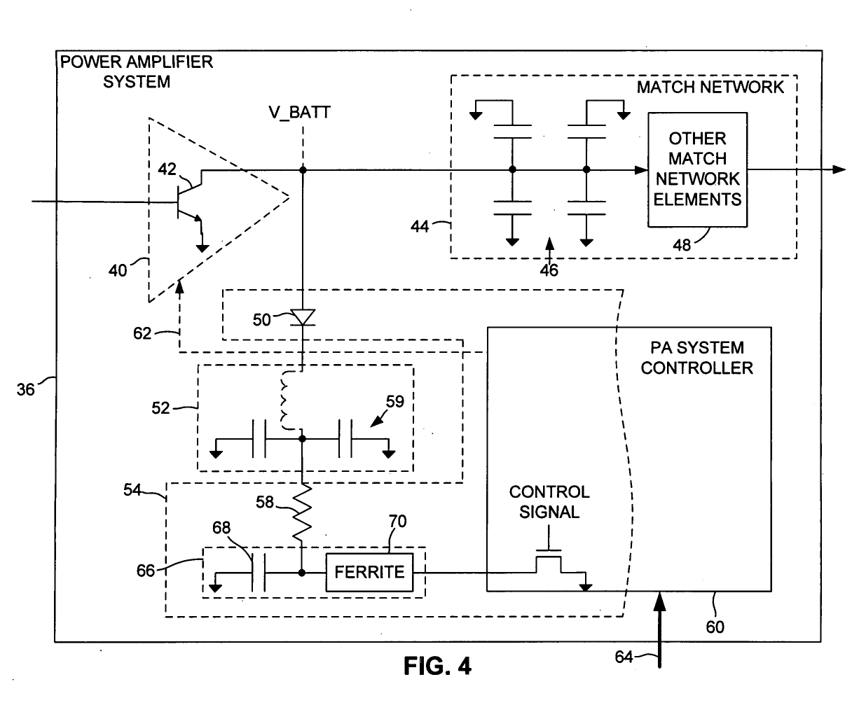

The above-described power amplifier system 36 is illustrated in further detail in FIG. 4. In the exemplary embodiment, inductance 52 comprises two capacitors in parallel, together defining a capacitor circuit 59 that exhibits substantial parasitic inductance (indicated by a dashed-line inductor symbol) when the transmitter is in operation. It is well understood in the art that capacitors and inductors have parasitic inductance and parasitic capacitance, respectively. As a circuit comprising a capacitance and inductance in series with each other will oscillate, it follows from the existence of parasitic inductance and parasitic capacitance that all capacitors and inductors will oscillate or self-resonate when stimulated with a signal having a frequency above a certain threshold, known as the self-resonant frequency. For example, a capacitor does not behave as a so-called “ideal capacitor” when stimulated with a signal having a frequency near or above its self-resonant frequency. Considering capacitance as a function of frequency, as the frequency of the stimulation signal increases, the effects of parasitic inductance become more pronounced until the operational frequency reaches the self-resonant frequency, at which point the effective capacitance becomes substantially zero, as its inherent capacitance is canceled by its parasitic inductance.

In the exemplary embodiment, capacitor circuit 59 is selected to have a resonant frequency substantially below the operational frequency, i.e., the frequency of the RF signal that power amplifier 40 outputs, so that in operation (i.e., when the wireless mobile telecommunication device is transmitting) capacitor circuit 59 can be expected to be beyond the point of self-resonance and thus have essentially zero capacitance and substantial parasitic inductance. This parasitic inductance of capacitor circuit 59 coupled with shunt capacitors 46 substantially decreases the total capacitance at the output of power amplifier 40 below the capacitance of shunt capacitors 46 alone. In contrast, as described above, in high-power mode, the total capacitance at the output of power amplifier 40 is essentially due to shunt capacitors 46 alone. The change in capacitance maintains the efficiency of power amplifier 40, as can be shown through load line analysis.

Although in the exemplary embodiment capacitor circuit 59 includes two capacitors, in other embodiments it can include more or fewer capacitors or other suitable devices having capacitance. Two or more capacitors in parallel, each having, for example, a capacitance of 100 pF, as shown in the exemplary embodiment, can have a lower resistive loss or higher Q, and accordingly, less loss than a single 200 pF capacitor would have, and would therefore provide greater efficiency in the low-power mode described below than a single 200 pF capacitor would provide.

Although in the exemplary embodiment inductance 52 (FIG. 3) is defined by the parasitic inductance of capacitor circuit 59 (FIG. 4), in other embodiments inductance 52 can be defined by any other suitable devices or structures. For example, inductance 52 alternatively can be defined in whole or part by the inductance of a circuit trace, bondwire, or other structure. In such other embodiments, a suitable blocking capacitor can be included to prevent a DC path from the output of power amplifier 40 to ground.

In the exemplary embodiment, switching circuit 54 can include a diode 50 and portions of a power amplifier system controller 60. Switching circuit 54 is coupled to circuit ground potential and can be activated to couple the cathode terminal of diode 50 to circuit ground potential. Power amplifier system controller 60 can be a logic device that provides various control functions relating to power amplifier 40, such as providing power amplifier 40 with one or more signals 62 that control bias, gain, power level, etc., of power amplifier 40. As indicated by the one or more signal lines 64, power amplifier system controller 60 can receive input signals provided by a controller (not separately shown for purposes of clarity) that is included in baseband subsystem 14 or elsewhere and which provides centralized control of various other functions of the mobile wireless telecommunication device. In addition to such functions, power amplifier system controller 60 can provide the above-referenced control signal that operates switching device 56 (FIG. 3). As shown in FIG. 4, switching device 56 can be a MOSFET (Metal-Oxide-Semiconductor Field-Effect Transistor), as such a device can readily be configured as a switch having an impedance of 2.0 megohms or more in its “OFF” state.

Diode 50 can be any suitable type of diode, such as a positive-intrinsic-negative (PIN) diode. In other embodiments, a device or circuit that functions as a diode can be included instead of diode 50. The anode terminal of diode 50 is connected to the output of power amplifier 40. The cathode terminal of diode 50 is connected to inductance 52.

Switching circuit 54 can further include a filter 66, comprising, for example, a capacitor 68 and an inductive isolation device such as a ferrite core 70. Filter 66 inhibits RF energy produced at the output of power amplifier 40 from adversely affecting power amplifier system controller 60.

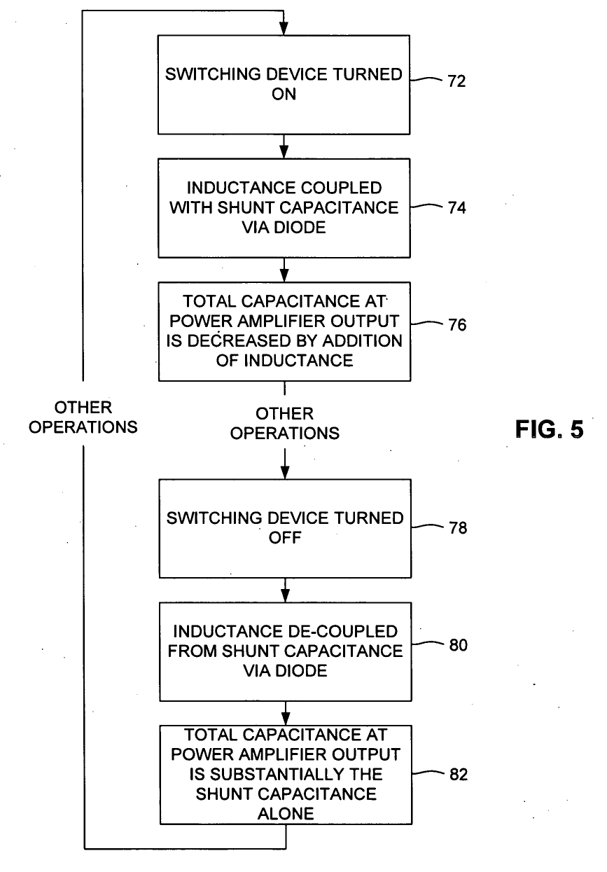

The operation of the above-described power amplifier system 36 is presented in flow diagram form in FIG. 5. As indicated by block 72, in instances in which switching device 56 (FIG. 3) is turned on, i.e., in low-power mode, inductance 52 is coupled with shunt capacitors 46 via diode 50, as indicated by block 74. More specifically, in low-power mode, switching device 56 is closed, and diode 50 is forward biased, as resistor 58 draws current through a DC path between the positive voltage (V_BATT) and ground potential. As a result, inductance 52 is coupled via diode 50 with shunt capacitors 46. Coupling inductance 52 with shunt capacitors 46 lowers the total capacitance at the output of power amplifier 40, as indicated by block 76. In the exemplary embodiment, the total capacitance at the output of power amplifier 40 is decreased through the effect of parasitic inductance of capacitor circuit 59 on the capacitance of shunt capacitors 46.

It should be noted that the mobile wireless telecommunication device can switch between high-power mode and low-power mode from time to time, in accordance with any conventional or other suitable power mode-switching criteria. As described above, the criteria can include those that are conventionally used in mobile wireless telecommunication device power control, such as distance from the nearest base station. As in a conventional system, such switching can thus occur at any time, including while a telephone call is taking place, i.e., while a party is talking. Alternatively, the criteria can relate to the two or more standards under which a dual-mode (or multi-mode) mobile wireless telecommunication device is capable of operating (e.g., GSM versus EDGE). In any event, during the times when it is not switching between high-power and low-power mode, the mobile wireless telecommunication device can function in the conventional manner, allowing a mobile user to make and receive telephone calls, etc. Accordingly, operation of the mobile wireless telecommunication device during times when it is not switching between high-power mode and low-power mode is not described herein, and any operation that occurs during those times is indicated in FIG. 5 by the notation “other operations.”

As indicated by block 78, in instances in which switching device 56 (FIG. 3) is turned off, i.e., in high-power mode, capacitor circuit 59 is decoupled from shunt capacitors 46 via diode 50, as indicated by block 80. The total capacitance at the output of power amplifier 40 is thus essentially defined by the capacitance of shunt capacitors 46 alone, as indicated by block 82. More specifically, in high-power mode, switching device 56 is open, effectively creating an open circuit, and preventing resistor 58 from drawing current. This also thereby prevents forward-biasing diode 50, i.e., prevents diode 50 from conducting. As diode 50 is non-conductive in high-power mode, inductance 52 advantageously has, for purposes here, essentially no effect on the total capacitance at the output of power amplifier 40. Furthermore, diode 50 advantageously has essentially no effect on the impedance matching function of matching network 44. It is important to note that because switching device 56 effectively creates an open circuit, i.e., prevents a DC path to ground on the cathode side of diode 50, even a relatively high-power RF signal that may be produced at the output of power amplifier 40 will not undesirably forward-bias diode 50. The above-described arrangement thus obviates a need for circuitry that provides a high reverse bias voltage across diode 50.

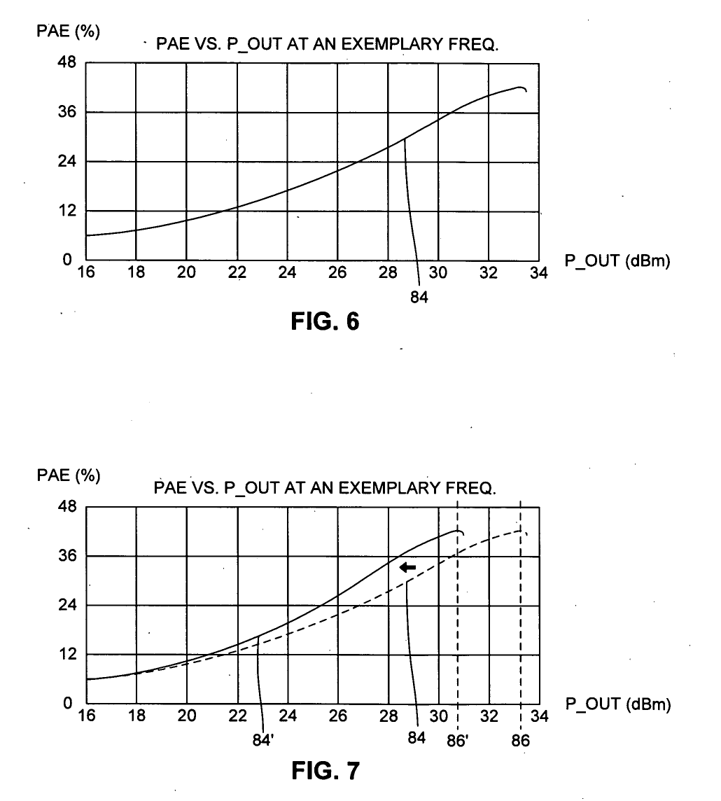

In FIG. 6 power-added efficiency (PAE) 84 is shown plotted against transmitted RF power (P_OUT) at a typical operational frequency, representing operation of power amplifier system 36 (FIGS. 3 and 4) with switching device 56 (and thus diode 50) in an OFF state, i.e., in high-power mode. In FIG. 7 power-added efficiency (PAE) 84 is likewise shown plotted against transmitted RF power (P_OUT) at a typical operational frequency, representing operation of power amplifier system 36 with switching device 56 (and thus diode 50) in an ON state, i.e., in low-power mode. Comparing FIG. 7 with FIG. 6, note that the entire efficiency curve (PAE) 84′ in FIG. 7 is shifted to the left, effectively relocating the peak efficiency of power amplifier 40 from position 86 to position 86′. In other words, peak efficiency moves along with transmitted RF output power. Stated yet another way, whether operating at a lower transmitted RF output power or higher transmitted RF output power, peak efficiency is substantially maintained regardless of the transmitted RF output power level.

While various embodiments of the invention have been described, it will be apparent to those of ordinary skill in the art that many more embodiments and implementations are possible that are within the scope of this invention. Accordingly, the invention is not to be restricted except in light of the following claims.

What is claimed is:

1. A radio frequency (RF) transmitter, comprising:
a power amplifier operable in a high-power mode and a low-power mode;
shunt capacitance coupled to an output of the power amplifier;
an inductance; and
a switching circuit, the switching circuit coupling the inductance to the shunt capacitance in response to a control signal indicating operation in a low-power mode and decoupling the inductance from the shunt capacitance in response to a control signal indicating operation in a high-power mode.

2. The RF transmitter claimed in claim 1, wherein:
the switching circuit comprises a diode and a switching device, an anode terminal of the diode is coupled to the output of the power amplifier, and the switching device is coupled between a cathode terminal of the diode and a circuit ground potential; and
the switching device has an ON state and an OFF state and provides a high impedance between the cathode terminal of the diode and the circuit ground potential in the OFF-state.

3. The RF transmitter claimed in claim 2, wherein the switching device comprises a MOSFET.

4. The power amplifier circuit claimed in claim 2, wherein:
the switching circuit further comprises a resistor circuit comprising at least one resistor;
a first terminal of the resistor circuit is coupled to the cathode terminal of the diode;
a first pole terminal of the switching device is coupled to a second terminal of the resistor circuit; and
a second pole terminal of the switching device is coupled to the circuit ground potential.

5. The RF transmitter claimed in claim 4, wherein the switching device comprises a MOSFET.

6. The RF transmitter claimed in claim 1, wherein the inductance comprises a plurality of capacitors having parasitic inductance, each capacitor having a first terminal coupled to a cathode terminal of the diode and a second terminal coupled to a circuit ground potential.

7. The RF transmitter claimed in claim 1, wherein the switching circuit comprises a filter circuit interposed between the output of the power amplifier and a source of the control signal.

8. A mobile wireless telecommunication device, comprising:
a user interface;
an antenna;
a baseband subsystem coupled to the user interface; and
a radio frequency (RF) subsystem coupled to the baseband subsystem and the antenna, the RF subsystem comprising a transmitter portion and a receiver portion, the transmitter portion comprising a modulator, an upconverter and a power amplifier system, the power amplifier system comprising:
a power amplifier operable in a high-power mode and a low-power mode;
shunt capacitance coupled to an output of the power amplifier;
an inductance; and
a switching circuit, the switching circuit coupling the inductance to the shunt capacitance in response to a control signal indicating operation in a low-power mode and decoupling the inductance from the shunt capacitance in response to a control signal indicating operation in a high-power mode.

9. The mobile wireless telecommunication device claimed in claim 8, wherein:
the switching circuit comprises a diode and a switching device, an anode terminal of the diode is coupled to the output of the power amplifier, and the switching device is coupled between a cathode terminal of the diode and a circuit ground potential; and
the switching device has an ON state and an OFF state and provides a high impedance between the cathode terminal of the diode and the circuit ground potential in the OFF-state.

10. The mobile wireless telecommunication device claimed in claim 9, wherein the switching device comprises a MOSFET.

11. The mobile wireless telecommunication device claimed in claim 9, wherein:
the switching circuit further comprises a resistor circuit comprising at least one resistor;
a first terminal of the resistor circuit is coupled to the cathode terminal of the diode;
a first pole terminal of the switching device is coupled to a second terminal of the resistor circuit; and
a second pole terminal of the switching device is coupled to the circuit ground potential.

12. The mobile wireless telecommunication device claimed in claim 11, wherein the switching device comprises a MOSFET.

13. The mobile wireless telecommunication device claimed in claim 8, wherein the inductance comprises a plurality of capacitors having parasitic inductance, each capacitor having a first terminal coupled to a cathode terminal of the diode and a second terminal coupled to a circuit ground potential.

14. The mobile wireless telecommunication device claimed in claim 8, wherein the switching circuit comprises a filter circuit interposed between the output of the power amplifier and a source of the control signal.

15. A method for load line switching in a portable radio frequency (RF) transmitter having a power amplifier and a shunt capacitance at an output of the power amplifier, comprising:
coupling an inductance to the shunt capacitance in response to a control signal indicating operation in a low-power mode; and
decoupling the inductance from the shunt capacitance in response to a control signal indicating operation in a high-power mode.

16. The method claimed in claim 15, wherein:
coupling an inductance to the shunt capacitance comprises activating a switching device coupled between a cathode terminal of a diode and a circuit ground potential, wherein an anode terminal of the diode is coupled to the output of the power amplifier, and activating the switching device comprises turning the switching device to an ON state providing a low-impedance path between a cathode terminal of the diode and the circuit ground potential; and
decoupling the inductance from the shunt capacitance comprises de-activating the switching device by turning the switching device to an OFF state providing a high-impedance path between the cathode terminal of the diode and the circuit ground potential.

17. The method claimed in claim 16, wherein:
coupling an inductance to the shunt capacitance comprises activating a MOSFET by turning the MOSFET to an ON state; and
decoupling an inductance from the shunt capacitance comprises de-activating the MOSFET by turning the MOSFET to an OFF state.
